(19) United States
(12) Patent Application Publication
(10) Pub. No.: US 2007/0088827 A1
(43) Pub. Date: Apr. 19, 2007

(54) Messages with forum assistance

(75) Inventors: Bryan T. Starbuck, Redmond, WA (US); Donald C. Weed, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/251,163

(22) Filed: Oct. 14, 2005

(51) Int. Cl. G06F 15/173

(52) U.S. Cl. 709/226

(57) ABSTRACT

Embodiments of messages with forum assistance are presented herein.

### BACKGROUND

As the amount of functionality that is available on a computing device continues to increase so to does the complexity of the computing device. To minimize user frustration, software and hardware is typically configured to need minimal user intervention, even when being installed on the computing device. However, the lack of the user intervention also results in the isolation of the user from the operation of the computing device such that the user may not be aware as to how the software and hardware interacts, one with another. Therefore, this isolation may result in the user being ill prepared to address errors when encountered during the operation of the computing device.

When encountering an error message, for instance, a user is typically provided with little or nor explanation regarding the error. For example, when the error is identified in the error message, even savvy computer users may be at a loss as to how to correct the error. Therefore, rather than correct the error, the user generally reboots the computing device and continues on as before, hoping that the reboot solved the problem. However, this may result in only a temporary solution which can lead to the user encountering the same or even greater problems in the future.

### SUMMARY

Messages with forum assistance are described. In an implementation, a message includes a link that is selectable to obtain information, from one or more forums, that relate to the message using text taken from the message.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an exemplary implementation that is operable to employ techniques to assist a user with an error message using one or more forums.

FIG. 2 is an illustration of a system in an exemplary implementation showing forum services and a client of FIG. 1 in greater detail.

FIG. 3 is an illustration of an exemplary implementation showing a user interface as outputting the error message having the forum link of FIG. 2.

FIG. 4 is a flow diagram depicting a procedure in an exemplary implementation in which an error message is configured to include a link that is selectable, when output, to navigate to a forum that includes information that relates to the error.

FIG. 5 is a flow diagram depicting a procedure in an exemplary implementation in which text of an error message is automatically used to search forums for information related to the described error.

FIG. 6 is a flow diagram depicting a procedure in an exemplary implementation in which forums are preprocessed to derive search results that relate to particular errors.

The same reference numbers are utilized in instances in the discussion to reference like structures and components.

### DETAILED DESCRIPTION

### Overview

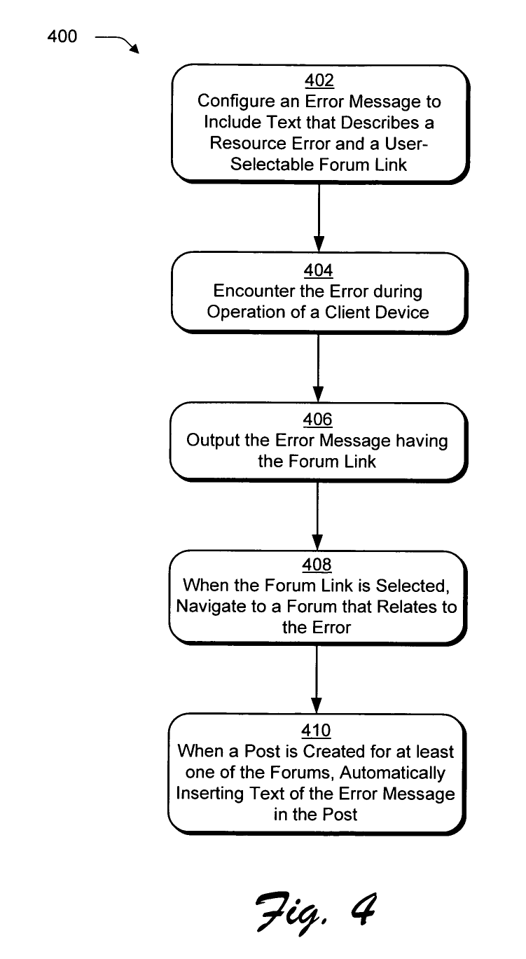

When error messages occur, users are often left with little or no explanation regarding how to resolve the errors. Techniques are described, in which, a forum search for information related to an error message is performed when a message (e.g., an error message) is encountered. For example, the error message may include text which describes the error and a user-selectable link to obtain information related to the error. When the link is selected, the text of the error message may be automatically used to search forums (e.g., newsgroups) for the information relating to the error. Thus, by selecting the link the user may be automatically presented with information relating to the error. The search may be performed in a variety of ways, such as by performing a new search each time the link is selected, navigating to pre-filtered search results that are indicated as “helpful” or “complete” by previous users, and so on, further discussion of which may be found in relation to FIGS. 4-6.

In the following description, an exemplary environment is first described which is operable to employ forum assistive techniques for error messages. Exemplary procedures are then described which are operable in the exemplary environment, as well as in other environments.

### Exemplary Environment

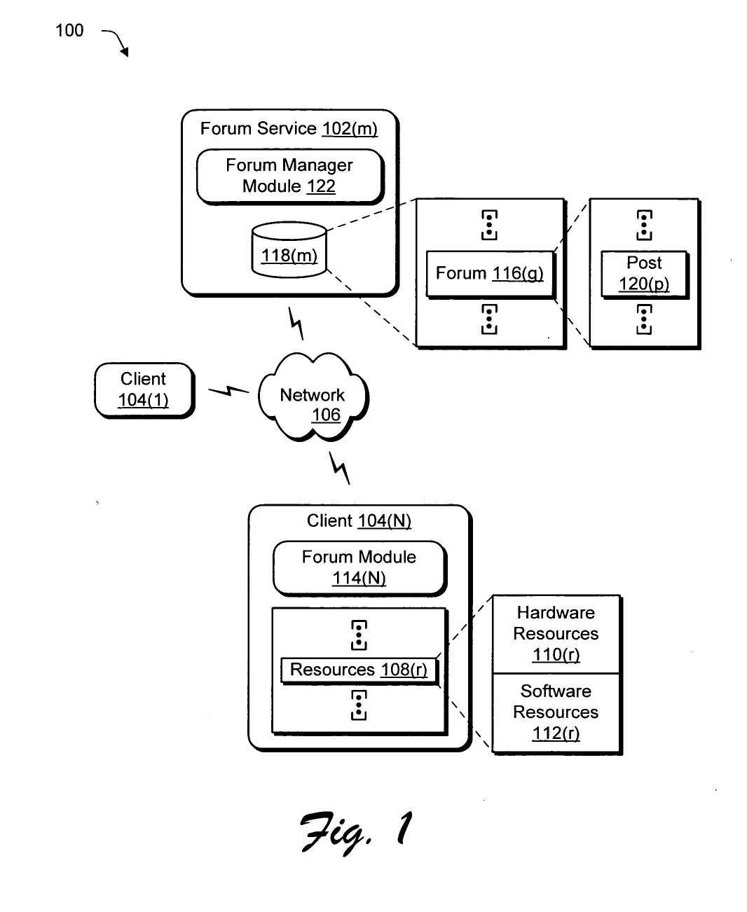

FIG. 1 illustrates of an environment 100 in an exemplary implementation that is operable to employ techniques to provide forum assistance related to error messages. The illustrated environment 100 includes a plurality of forum services 102(m) (where “m” can be any integer from one to “M”) and a plurality of clients 104(1), . . . , 104(N) that are communicatively coupled, one to another, over a network 106. The clients 104(1)-104(N) may be configured in a variety of ways to access the network. For example, one or more of the clients 104(1)-104(N) may be configured as a computing device, such as a desktop computer, a mobile station, an entertainment appliance, a set-top box communicatively coupled to a display device, a wireless phone, a game console, and so forth. Thus, the clients 104(1)-104(N) may range from full resource devices with substantial memory and processor resources (e.g., personal computers, game consoles) to low-resource devices with limited memory and/or processing resources (e.g., traditional set-top boxes, hand-held game consoles). The clients 104(1)-104(N) may also relate to a person and/or entity that operate the clients. In other words, one or more of the clients 104(1)-104(N) may describe logical clients that include users, software, and/or devices.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

Client 104(N) is illustrated as having a plurality of resources 108(r), where “r” can be any integer from one to “R”, that are configured to provide functionality during the operation of the client 104(N). For example, the resources 108(r) may be configured as hardware resources 110(r), such as processors and memory, peripheral devices (e.g., printers, scanners, digital cameras, music players), input devices (e.g., keyboards, voice-input devices and cursor-control devices), display devices (e.g., monitors, projectors and motion-output devices), and so on. The resources 108(r) may also be configured as software resources 112(r), such as executable modules configured as applications, operating systems, third-party plug-in modules, drivers, and so forth. Thus, the client 104(N) may include a wide variety of resources which are operable to provide functionality to the client 104(N).

As previously described, however, errors may be encountered during the operation of the resources 108(r). To provide the client 104(N) (i.e., a user) with additional information regarding the encountered errors, a forum module 114(N) may be executed to obtain additional information related to the error from the forum service 102(m) over the network 106.

The forum service 102(m) is illustrated as maintaining a plurality of forums 116(g), where “g” can be any integer from one to “G”, in storage 118(m). Forums 116(g) are electronic discussion groups (e.g., a bulletin board), each of which are typically devoted to discussion of a particular topic. Forms 116(g), for instance, may be configured as newsgroups, discussion groups, email threads, blogs (i.e., web logs), web forums, and so on. Each of the illustrated forums 116(g) includes a plurality of posts 120(p), which are messages that have been addressed to the respective forum 116(g) rather than a specific individual, e.g., the client 104(N). Additionally, the forums 116(g) may be “threaded” such that various topics (e.g., forums) pertaining to a central theme may be combined. For instance, the posts 120(p) may be threaded according to a particular discussion of a central theme.

The forum service 102(m) is illustrated as including a forum manager module 122 that is executable to manage the forums 116(g) and posts 120(p) in the respective forums 116(g). For example, client 104(1) may create a post 120(p) for a particular forum 116(g), which may be managed by the forum manager module 122. When the post 120(p) is requested by client 104((N), the post 120(p) may be communicated over the network 106 to the client 104(N) by the forum manager module 122. The forum manager module 122 may provide a wide variety of additional functionality, further discussion of which may be found later in the description.

As previously described, errors may be encountered during operation of the plurality of resources 108(r) of the client 104(N). To gain additional information regarding the errors, the forum module 114(N), when executed, may locate forums 116(g) that have information (e.g., posts 120(p)) related to the error. These posts 120(p) may then be output at the client 104(N) for viewing such that a user may be provided with this information. Thus, the client 104(N) may learn information provided by other clients (e.g., client 104(1)) that may assist the client 104(N) in correcting the error, information regarding the source of the error, experiences with the error by the other client 104(1), and so on. In an implementation, navigation to the forum service 102(m) and location of the relevant information is performed automatically upon selection of a link included in the error message, further discussion of which may be found in relation to the following figure.

Although the following discussion describes the use of error messages and forums, these techniques may be applied in a variety of other instances. For example, a mechanism which maps from a source user interface to a thread destination is automated by using text and data from the source to match with the correct destination. Therefore, this mechanism may also be employed such that a newsgroup which discusses books may be utilized by a book seller such that a hyperlink is placed in the catalog of books which causes the user to navigate to the relevant discussion. Therefore, the user may be provided with a web page that shows a subset of newsgroup threads that specifically relate about that particular book in the catalog. In this way, the hyperlinks are built into the source user interface, instead of having the user go to a separate search engine. This functionality may also leverage post rating, poster rating, and so on besides the text of the threads to locate particular threads of interest which will be described in further detail below. Further, the functionality may also leverage additional information about the source, such as a user's language, application type that incorporates the functionality (e.g., word processor, etc.), and so on. Further discussion of these features may be found in relation to the following figures.

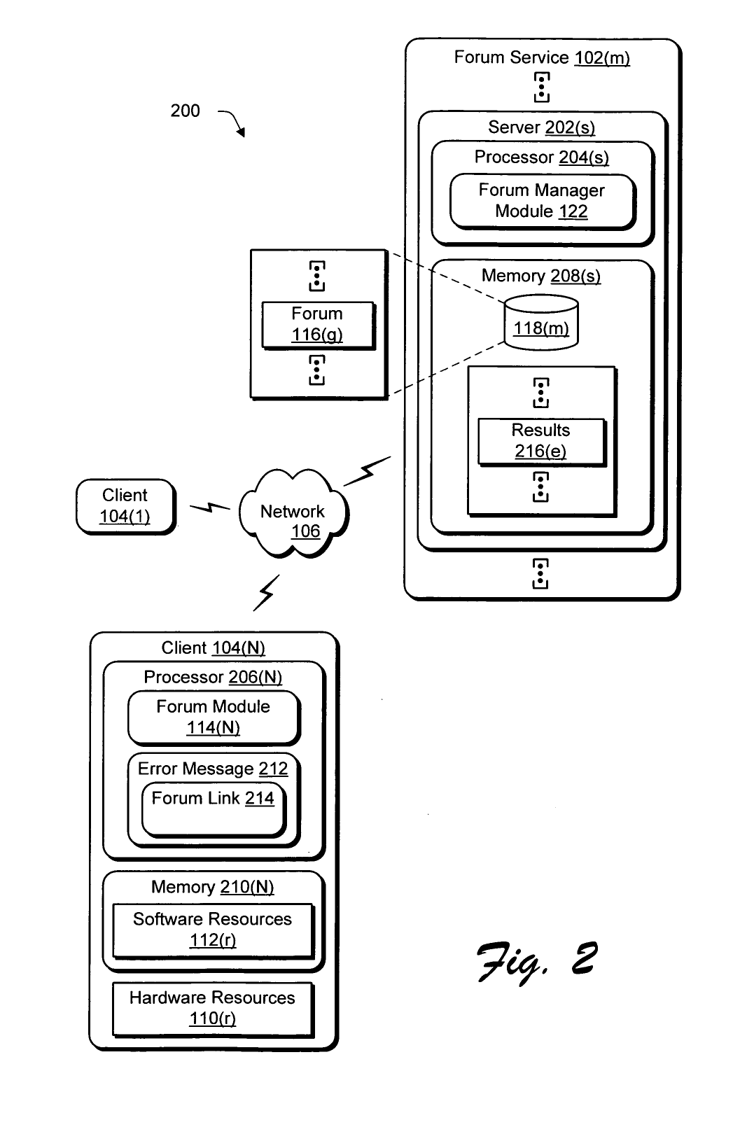

Generally, any of the functions described herein can be implemented using software, firmware (e.g., fixed logic circuitry), manual processing, or a combination of these implementations. The terms “module” and “logic” as used herein generally represent software, firmware, or a combination of software and firmware. In the case of a software implementation, the module or logic represents program code that performs specified tasks when executed on a processor (e.g., CPU or CPUs). The program code can be stored in one or more computer readable memory devices, further description of which may be found in relation to FIG. 2. The features of the forum assistive techniques described below are platform-independent, meaning that the techniques may be implemented on a variety of commercial computing platforms having a variety of processors.

FIG. 2 illustrates a system 200 in an exemplary implementation showing the forum services 102(m) and the client 104(N) of FIG. 1 in greater detail. The forum service 102(m) is illustrated as being implemented by a plurality of servers 202(s), where “s” can be any integer from one to “S”, and the client 104(N) is illustrated as a client device. The servers 202(s) and the client 104(N) include respective processors 204(s), 206(N) and respective memories 208(s), 210(N).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 208(s), 210(N) is shown, respectively, for the client 104(N) and the servers 202(s), a wide variety of types and combinations of memory may be employed, such as random access memory (RAM), hard disk memory, removable medium memory, and so forth.

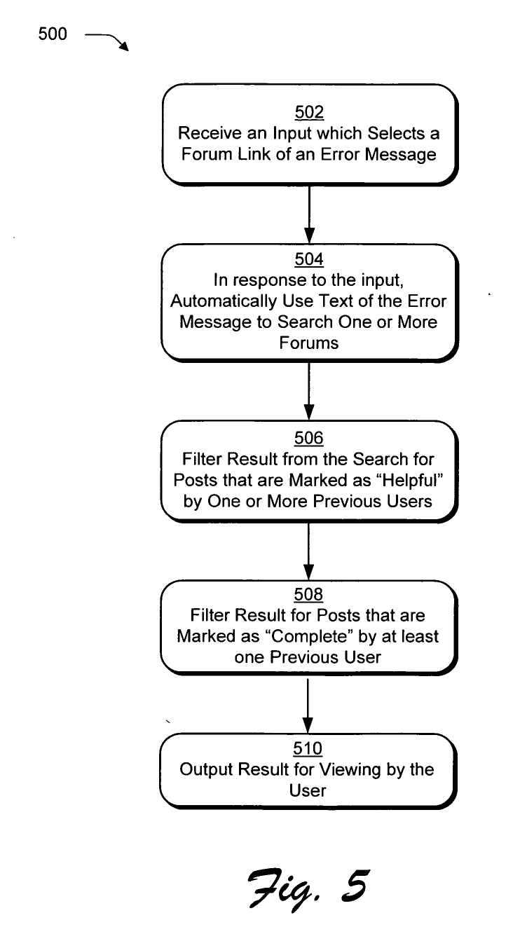

The client 104(N) is illustrated as executing the forum module 114(N) on the processor 206(N), which is also storable in memory 210(N). The forum module 114(n) is representative of functionality that is executable to provide forum information that is related to errors encountered during the operation of the hardware resources 110(r) and/or software resources 112(r) of the client 104(N). For example, the forum module 114(N) may be utilized to configure an error message 212 to include a forum link 214. The forum link is selectable to obtain information from the forums 116(g) over the network 106 that relate to the error. For example, selection of the forum link 214 may cause text included in the error message which describes the error to be utilized in a search by the forum module 114(N) of forums 116(g) for related information, further discussion of which may be found in relation to FIG. 5.

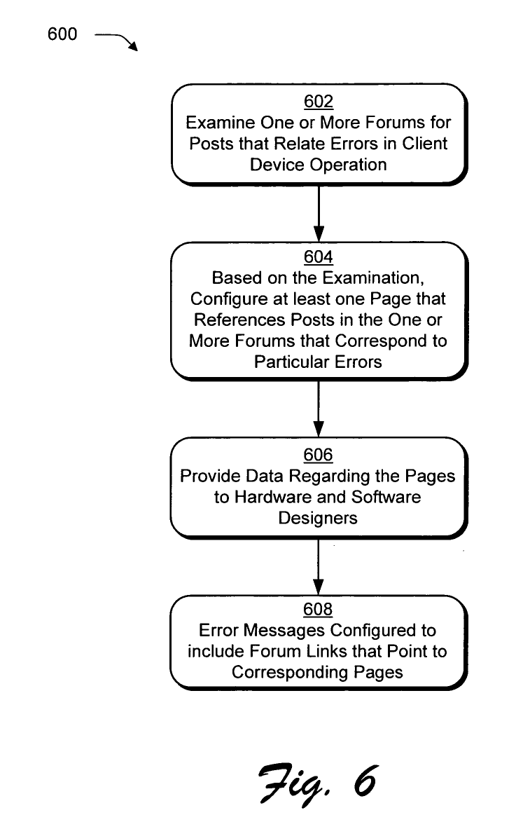

In another example, selection of the forum link 214 automatically navigates the client 104(N) to results 216(e) (where “e” can be any integer from one to “E”) that correspond to the error being indicated by the error message 212. For instance, the forum manager module 122 may pre-process the forum 116(g) and store results 216(e) of the processing according to the type of error encountered at one or more particular network addresses. The forum link 214 may point to one or more of these network addresses to obtain information from the forums 116(g). Further discussion of pre-processing of the forums 116(g) may be found in relation to FIG. 6.

Results of a forum search may also be filtered such that a client 104(N) is more likely to obtain information that is relevant to the error. For example, posts of the forums 116(g) may be rated by other clients for helpfulness (e.g., “was this post helpful regarding this error”), completeness (e.g., “was this post complete regarding this error”), and so on. These ratings may then be utilized by the forum module 114(N) and/or the forum manager module 122 to filter results of the search for “helpful” and “complete” posts. Further discussion of filtering of search results may be found in relation to FIG. 5.

The forum module 114(N) may also provide additional functionality to ease future searches to obtain information related to an error. For example, a search for an error message in the forums 116(g) may turn up limited results that are not helpful. Accordingly, to obtain additional information, a post may be created through execution of the forum module 114(N) that automatically inserts the text of the error message such that other clients (e.g., client 104(1)) may reply to the post. These replies may then be obtained later by the client 104(N), such as when the error is again encountered, at a scheduled time, and so on.

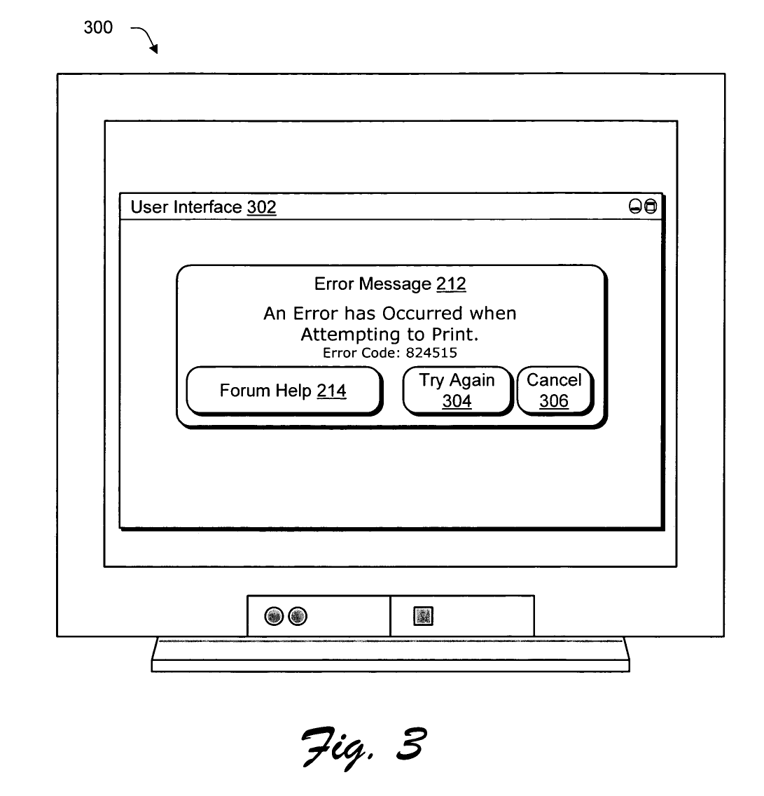

FIG. 3 illustrates an exemplary implementation of a user interface 302 as outputting the error message 212 of FIG. 2 having the forum link 214. The error message 212 includes text which describes an error encountered during operation of a resource, which in this instance states “An Error has Occurred when Attempting to Print”. The error message 212 also includes an error code, which may be utilized in locating particular posts and forums having the posts.

The forum link 214 is illustrated as a button that is operable as a hyperlink to navigate to information obtained from the forums 116(g) of FIG. 2 as previously described. The error message 212 also includes a “try again” 304 button to repeat the attempted action (e.g., printing) and a “cancel” 306 button to cancel printing. Although the forum link 214 is illustrated as a button, the forum link 214 may be configured as a variety of hyperlinks, such as underlined text that is selectable, highlighted text, an image (e.g., an image of a question mark), and so on.

### Exemplary Procedures

The following discussion describes forum assistive techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2 and the user interface 302 and error message 304 of FIG. 3.

FIG. 4 depicts a procedure 400 in an exemplary implementation in which an error message is configured to include a link that is selectable, when output, to navigate to a forum that includes information that relates to the error. An error messages is configured to include text that describes a resource error and a user-selectable forum link (block 402). For example, a programmer may configure an operating system to output an error message when a particular error is encountered. The message may be configured to include the forum link that is selectable to obtain information related to the message, such as through navigation of a pre-pressed search result, perform a search using text of the message through execution of the forum module 114(N), and so on.

During operation of the client device, the error is encountered (block 404). For example, a hardware error may be encountered such that the client device is unable to perform a desired action, a software error may be encountered in the execution of a module, and so on. Therefore, the error message is output having the forum link (block 406), such as the error message 120 and forum link 122 of FIG. 3.

When the forum link is selected, the client 104(N) is navigated to a forum that relates to the error (block 408). For example, the client 104(N) may be navigated to a network address of the forum to obtain posts which relate to the error. In some situations, however, the forums may contain little or no information that is related to the error. Therefore, in such an instance the client 104(N) may create a post requesting information related to the error from other clients, e.g., client 104(1). When the post is created, the text of the error message may be automatically inserted into the post (block 410), such as through execution of the forum module 114(N). Therefore, subsequent clients which encounter the same message may readily find the post and share any found solutions, experiences, and so on.

FIG. 5 depicts a procedure 500 in an exemplary implementation in which text of an error message is automatically used to search forums for information related to the described error. An input is received which selects a forum link of an error message (block 502). For example, as before the client may select the forum link 304 of FIG. 3 that is configured as a button through use of a cursor-control device.

In response to the input, text of the error message is automatically used to search one or more forums (block 504). The text “An Error has Occurred when Attempting to Print” as shown in FIG. 3, for instance, may be copied into a user input portion of a search window (e.g., in a help user interface) to search for help related to the error. In this way, the user does not need to manually enter the text or similar text to perform the search, but rather, may select a forum hyperlink to cause the search to be performed automatically.

Results of the search are filtered for posts that are marked as “helpful” by one or more previous users (block 506). The previous users, for instance, may read posts 120(p) of one or more forums 116(g) and rate the posts (e.g., “helpful”, “sort of helpful”, “not helpful”, and so on) based on how helpful the post was in relation to the error, such as to correct the error, understand a source of the error, and so forth. These ratings may then be used to quickly locate helpful posts for output to subsequent users, thereby increasing the likelihood that the subsequent users are provided with useful information. In this way, the subsequent users may leverage the experience of the previous users (e.g., user 104(1)) with the posts 120(p).

Likewise, results for posts that are marked as “complete” by at least one previous user may be filtered (block 508). Like marking posts as “helpful”, the completeness of the posts may also be rated to indicate to subsequent users that the; posts may be useful in relation to the error. Results of the filtering (blocks 506, 508) may then be output for viewing by the user (block 510), such as on a display device as illustrated in FIG. 3.

FIG. 6 depicts a procedure 600 in an exemplary implementation in which forums are preprocessed to derive search results that relate to particular errors. One or more forums are examined for posts that relate to an error in client device operation (block 602). For example, the forum manager module 122 may be executed to categorize errors based on error type such that corresponding errors may be found based on error type.

Based on the examination, at least one page is configured to reference posts in the one or more forums that correspond to particular errors (block 604). For example, the page may include network addresses of posts that are categorized by error type. Therefore, data regarding the pages may be provided to hardware and software designers (block 606) such that the designers may configure error messages to include forum links that point to corresponding pages (block 608). Thus, the designers may incorporate the functionality into the error messages in a simple manner.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
encountering an error in operation of a client device; and
outputting an error message that includes a forum link that is selectable to navigate to a forum which relates to the error.

2. A method as described in claim 1, wherein the navigation to the forum is performed over a network.

3. A method as described in claim 1, wherein the navigation to the forum is performed by using text included in the error message as a search term to locate one or more posts in the forum which relate to the text.

4. A method as described in claim 1, wherein the navigation to the forum is performed by:
navigating to a page which contains preconfigured search results that are sorted into a plurality of error categories;
locating at least one said error category that corresponds to the error; and
finding posts which are referenced by the at least one said error category.

5. A method as described in claim 1, wherein the error is encountered in an execution of a software resource on the client device.

6. A method as described in claim 1, wherein the error is encountered in operation of a hardware resource of the client device.

7. A method as described in claim 1, wherein the forum that relates to the error is filtered from a plurality of other forums based on relative helpfulness of postings of respective said forums, one to another, as indicated by user feedback relating to the respective postings.

8. A method as described in claim 1, wherein the forum that relates to the error is filtered from a plurality of other forums based on relative completeness of postings of the respective forums, one to another, as indicated by user feedback relating to one or more said forums.

9. A method as described in claim 1, further comprising outputting information obtained from at least one said forum and information which relates to the error which is stored locally on the client device.

10. A method comprising:
in response to selection of a forum link, searching one or more forums using text taken from a user interface having the forum link; and
outputting results of the search.

11. A method as described in claim 10, wherein the results of the search include posts from at least one said forum.

12. A method as described in claim 10, further comprising filtering the results of the search based on helpfulness of postings as indicated by user feedback.

13. A method as described in claim 10, further comprising filtering the results of the search based on completeness of postings as indicated by user feedback.

14. A method as described in claim 10, wherein the searching further includes using additional data not taken from the user interface when performing the search, in which, the additional data describes a source which output the user interface.

15. One or more computer readable media comprising computer executable instructions that, when executed, direct a computer to output a message and includes a link that is selectable to navigate over a network to a forum having information related to the message, in which, the forum is located using text taken from the message.

16. One or more computer readable media as described in claim 15, wherein the computer-executable instructions further configure the computer to automatically insert text included in the error message into a post at the forum.

17. One or more computer readable media as described in claim 15, wherein the message is an error message.

18. One or more computer readable media as described in claim 17, wherein the error relates to operation of a hardware or software resource of the computer.

19. One or more computer readable media as described in claim 15, wherein the link is a hyperlink.

20. One or more computer readable media as described in claim 15, wherein the information is provided via a plurality of postings created by a plurality of users when accessing the forum over the network.
